(19) United States
(12) Patent Application Publication
(10) Pub. No.: US 2010/0085644 A1
(43) Pub. Date: Apr. 8, 2010

(54) PROJECTION OBJECTIVE AND PROJECTION EXPOSURE APPARATUS FOR MICROLITHOGRAPHY

(75) Inventor: Hans-Juergen Rostalski, Oberkochen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/609,437

(22) Filed: Oct. 30, 2009

Related U.S. Application Data
(63) Continuation of application No. PCT/EP2008/003760, filed on May 9, 2008.

(30) Foreign Application Priority Data
May 14, 2007 (DE) 102007024214.1

(51) Int. Cl. G02B 17/08; G03B 27/70

(52) U.S. Cl. 359/602; 359/726; 355/66

(57) ABSTRACT

A projection objective of a projection exposure apparatus for microlithography serves for imaging an object arranged in an object plane onto a light-sensitive wafer in an image plane. The projection objective has a plurality of optical elements which have at least one reflective element and at least one refractive element. The plurality of optical elements lie, in the light propagation direction of the useful light, downstream of the reflective element on a common straight optical axis. The at least one reflective element has a substrate having at least one opening through which light beams can pass. The at least one reflective element is at least partly made from a material which suppresses stray light impinging on the reflective element rearward.

### CROSS-REFERENCE TO RELATED APPLICATIONS

This application is a continuation of, and claims benefit under 35 USC 120 to, international application PCT/EP2008/003760, filed May 9, 2008, which claims benefit of German Application No. 10 2007 024 214.1, filed May 14, 2007. International application PCT/EP2008/003760 is hereby incorporated by reference in its entirety.

### FIELD

The disclosure relates to a projection objective for microlithography for imaging an object arranged in an object plane onto a light-sensitive wafer in an image plane, comprising a plurality of optical elements which have at least one reflective element and at least one refractive element and lie, in the light propagation direction of the useful light, downstream of the at least one reflective element on a common straight optical axis, wherein the at least one reflective element has a substrate having at least one opening through which light beams can pass. The disclosure furthermore relates to a projection exposure apparatus for microlithography comprising such a projection objective.

### BACKGROUND

Projection objectives are used in semiconductor microlithography for the fabrication of finely structured components, for example, in order to image an object provided with a pattern (reticle) onto a wafer. In this case, the object and the wafer are arranged in an object plane and image plane, respectively, of the projection objective. The wafer is provided with a light-sensitive layer, upon the exposure of which via light that passes through the projection objective the pattern of the object is transferred to the light-sensitive layer of the wafer. After possible multiple exposure and subsequent development of the light-sensitive layer, the desired structure arises on the wafer.

Projection objectives can be distinguished according to their design. A catadioptric projection objective has both reflective and refractive elements in the form of mirrors and lenses, for example. By contrast, if a projection objective has only refractive elements or only reflective elements, then it is called dioptric or catoptric, respectively.

The catadioptric projection objective known from U.S. Pat. No. 6,600,608 B1 has a plurality of lenses and mirrors which lie on a common straight optical axis. The optical elements are arranged in three subassemblies, which are dioptric, catadioptric and dioptric as seen in the light propagation direction of the useful light of the projection objective. The mirrors of the catadioptric subassembly each have an opening through which the light beams incident on the mirror can pass. The mirror surfaces are configured in light-reflective fashion, such that the light beams incident on the mirror surfaces are reflected in accordance with their impingement angle with respect to the surfaces.

The imaging quality of the known projection objective is determined by the imaging properties thereof, such that said projection objective should to the greatest possible extent be free of imaging aberrations and disturbing effects that impair the imaging quality.

In the case of the known projection objective, the imaging quality can be impaired by the occurrence of stray light or false light or so-called “ghost images”. Stray light arises in the case of a catadioptric projection objective, for example, by virtue of the fact that light beams which are reflected in an undesired manner at the surfaces of an optical element impinge on one of the mirrors of the projection objective rearward, pass through the mirror substrate and are reflected at the reflective mirror surface. These reflective light beams mix with the light beams proceeding as seen in the “regular” light propagation direction of the useful light and impair the imaging of the pattern onto the light-sensitive wafer.

### SUMMARY

The present disclosure provides a projection objective of the type mentioned in the introduction whose imaging quality is improved via particularly simple and cost-effective suppression of stray light. The disclosure achieves this by virtue of the fact that the at least one reflective element is at least partly made from a material which suppresses stray light impinging on the reflective element rearward.

The projection objective according to the disclosure of the projection exposure apparatus according to the disclosure is catadioptric and has a plurality of optical elements which lie, in the light propagation direction of the useful light, downstream of the at least one reflective element on a common straight optical axis. The reflective element of the projection objective according to the disclosure has a substrate provided with at least one opening through which the light beams can pass. Furthermore, the reflective element is at least partly made from such a material which suppresses or at least reduces the stray light impinging on the reflective element rearward. According to the disclosure, stray light impinging on the reflective element “rearward” should be understood to mean those light beams which run in direction from the image plane to the object plane, that is to say propagate counter to the light propagation direction of the useful light, and impinge on the reflective element at arbitrary angles. These light beams contributing to the stray light can for example impinge on the rear side of the substrate or else for example at least partly pass through the opening of the substrate and penetrate into the substrate of the reflective element obliquely with respect to the optical axis. The stray light suppression prevents, in particular, the stray light from impinging on the reflective surface of the reflective element and being scattered back to the image plane. The choice of material for the reflective element thus advantageously enables a stray light reduction that is particularly simple to realize since there is no need to provide in the projection objective an additional element, such as the shield known from the prior art, which fulfills this function. As a result, this type of stray light suppression can be employed in all catadioptric projection objectives independently of the distances between the optical elements thereof.

Furthermore, the manufacturing costs of the projection objective according to the disclosure are advantageously reduced significantly since the stray light suppression is brought about by the reflective element already accommodated in the projection objective, and not by an additional absorption shield. Moreover, additional costs caused, as in the case of the known projection objective, by positional adjustment or tilting of the absorption shield with respect to the optical axis are not caused.

It is furthermore advantageous that the use of the reflective element for stray light suppression does not cause undesired beam limiting of the light beams that pass through the projection objective, whereby the wafer is always completely exposed.

In a refinement of the projection objective, the substrate of the reflective element is at least partly made from the stray-light-suppressing material.

This measure has the effect that the basic body of the reflective element, namely the substrate itself, is utilized for stray light suppression, whereby the manufacture of the reflective element is advantageously particularly simple since only the choice of material for the substrate has to be taken into consideration and no additional structural measures have to be implemented on the reflective element. The substrate of the reflective element can be made completely or partly, that is to say only in partial regions, from the stray-light-suppressing material.

In a refinement of the projection objective, the substrate of the reflective element at least partly has a layer made from the stray-light-suppressing material.

This measure advantageously enables large-area stray light suppression in the region of the stray-light-suppressing layer. The layer can be made so thin, for example, that the substrate dimension of the reflective element is not significantly increased and the reflective element does not take up space unnecessarily. Furthermore, the reflective element can be produced particularly simply and cost-effectively since the stray-light-suppressing layer can be applied during the production process along the desired substrate dimension.

In a refinement of the projection objective, the layer is arranged under a reflective surface of the substrate.

This measure has the effect that the stray light that impinges on the substrate of the reflective element rearward no longer passes to the light-reflecting surface of the substrate since it is already nullified by the layer. This advantageously results in optimum stray light suppression, and at the same time possible beam damage to the substrate as a result of the stray light passing through is avoided to the greatest possible extent. Moreover, the light propagation in the projection injective from the object plane to the image plane is not impaired since the stray-light-suppressing layer is arranged under the reflective surface as seen in the light propagation direction of the useful light.

In a refinement of the projection objective, the layer is arranged directly under the reflective surface of the substrate.

This measure has the effect that not only stray light which passes from an arbitrary direction via the rear side of the substrate of the reflective element as far as the reflective surface but also that stray light which penetrates into the reflective element through the side walls of the reflective element which are adjacent to the opening are suppressed, even more effective stray light suppression advantageously being achieved thereby.

In a refinement of the projection objective, the layer is arranged along an entire extent of the reflective surface of the substrate.

This measure advantageously provides even more effective stray light suppression since the stray-light-suppressing layer is arranged along the entire mirror surface, as a result of which no stray light impinging rearward can pass as far as the reflective surface of the reflective element. Furthermore, the production of the reflective element is particularly simple and cost-effective since the stray-light-suppressing layer can be applied along the entire substrate extent during the production process without the need to cover the intermediate regions of the substrate that are not to be coated.

In a refinement of the projection objective, the layer is at least partly arranged along the opening of the substrate.

This measure has the effect that the stray light which passes through the opening and penetrates into the substrate via the side walls of the substrate obliquely with respect to the optical axis is absorbed, for example. The stray light suppression of the reflective element is advantageously additionally increased as a result of this. The layer can be arranged at the side walls of the substrate along the entire extent of the opening or only in partial regions of the substrate side walls.

In a refinement of the projection objective, the reflective element has a mount arranged at least partly at a rear side of the substrate, wherein the mount is at least partly made from the stray-light-suppressing material.

This measure has the advantage that the stray light impinging on the reflective element rearward is already effectively suppressed at the mount of the reflective element, whereby the substrate of the reflective element is protected even better against undesirable absorption of radiation. The material and geometry of the mount can be adapted to the respective desired properties of optimum stray light suppression. The mount can for example be made completely from the stray-light-suppressing material, or have only partial regions which are made from the stray-light-suppressing material.

In a refinement of the projection objective, the mount at least partly has a coating made from the stray-light-suppressing material.

This measure has the advantage that the stray light suppression is realized particularly cost-effectively and easily since the coating can be applied to a standard mount of the reflective element. The coating can be applied for example on the front side of the mount, said front side facing the substrate, or on the rear side of the mount.

In a refinement of the projection objective, the stray-light-suppressing material is light-absorbing.

This measure advantageously provides a particularly effective possibility for stray light suppression since the stray light incident on the rear side of the reflective element is absorbed and no stray light is reflected in the direction of the image plane. The absorption effect of the stray-light-suppressing material can be adapted for example to the respective wavelength of the light beams that pass through the projection objective.

In a refinement of the projection objective, the light-absorbing material is Zerodur.

A use of Zerodur as light-absorbing material for the substrate of the reflective element is particularly advantageous on account of its material properties since it has only a small expansion coefficient. Furthermore, this material is particularly homogeneous, such that the production of the reflective element can be realized in a particularly simple manner.

In a refinement of the projection objective, the stray-light-suppressing material is non-directionally light-scattering.

This measure has the effect that the stray light suppression is obtained by non-directional light scattering of the incident light beams in all directions, with the result that, advantageously, no appreciable backscattering of the stray light to the image plane occurs.

In a refinement of the projection objective, the stray-light-suppressing material is metal.

A use of metal as mount material or as coating material for the mount advantageously constitutes a particularly cost-effective measure for stray light reduction. The metal prevents the light that is reflected back to the reflective element downstream of the latter in the light propagation direction of the useful light from reaching the reflective surface of the element.

The at least one reflective element can be a mirror.

The present disclosure is particularly useful in the case of a refinement of the projection objective having optical elements that form a non-obscured imaging system. Such a projection objective can have two mirrors which are provided with openings and the reflective surfaces of which face one another. In such a case, the useful light uses only a respective mirror sector of the mirrors on one side of the opening. In particular, this projection objection can be one whose optical elements image an off-axis object field, which does not contain the optical axis, onto an off-axis image field.

The expression “opening” of the reflective element, particularly in the case of the above-mentioned projection objective whose optical elements image an off-axis object field onto an off-axis image field, also encompasses the case where the sector of the reflective element on which the useful light does not impinge is simply omitted.

In the case of such a projection objective which has a plurality of refractive elements downstream of the geometrically last reflective element and upstream of the image plane as seen in the light propagation of the useful light, and in which the stray light is produced by at least one reflection at at least one of the surfaces of at least one of the refractive elements, in particular at at least one surface of the last refractive element upstream of the image plane, in particular at the front surface of the last refractive element as seen in the light propagation direction, a particularly effective improvement in the imaging properties of the projection objective can be achieved by measures for stray light suppression at the first mirror as seen in the propagation direction of the useful light, that is to say the mirror which is geometrically closest to the image plane, by the reduction of the stray light proportion.

Furthermore, a projection exposure apparatus is provided which has an illumination system and a projection objective according to one or more of the configurations mentioned above.

Further advantages and features will become apparent from the description below.

It goes without saying that the features mentioned above and those yet to be explained below can be used not only in the combinations specified but also in other combinations or by themselves, without departing from the scope of the present disclosure.

### BRIEF DESCRIPTION OF THE DRAWINGS

The disclosure is explained and described in greater detail below on the basis of some selected exemplary embodiments in conjunction with the accompanying drawing, in which:

FIG. 1 shows a schematic illustration of a projection exposure apparatus for microlithography with a projection objective according to the disclosure;

FIG. 2 shows an exemplary embodiment of the projection objective in FIG. 1;

FIGS. 3A-3E show exemplary embodiments of a reflective element of the projection objective in FIG. 2 in longitudinal section; and

FIGS. 4A and 4B show a further exemplary embodiment of a projection objective for use in a projection exposure apparatus in accordance with FIG. 1, wherein FIG. 4A shows the projection objective with the useful light beam path and FIG. 4B shows the projection objective with a stray light beam.

### DETAILED DESCRIPTION

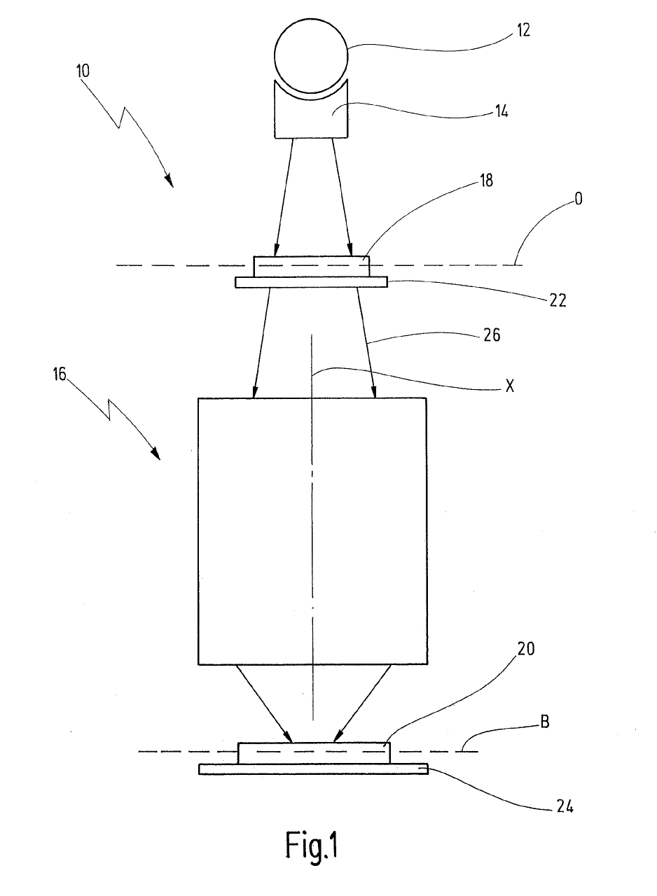

FIG. 1 schematically illustrates a projection exposure apparatus, which is provided with the general reference symbol 10 and which is used in semiconductor microlithography, for example, in order to produce finely structured components.

The projection exposure apparatus 10 has an illumination system 11 comprising a light source 12 and an illumination optical unit 14, and also a projection objective 16. The projection objective 16 serves for imaging an object 18 that is arranged in an object plane O and is provided with a pattern onto a light-sensitive wafer 20 arranged in an image plane B of the projection objective 16. The object 18 and the wafer 20 are inserted into a retainer 22 and a holder 24, respectively, during the operation of the projection exposure apparatus 10. Light beams 26 that are generated by the light source 12 and directed through the illumination optical unit 14 pass through the pattern of the object 18, run from the object plane O through the projection objective 16 toward the image plane B as seen in the light propagation direction of the useful light and thus transfer the pattern of the object 18 to the wafer 20 arranged in the image plane B.

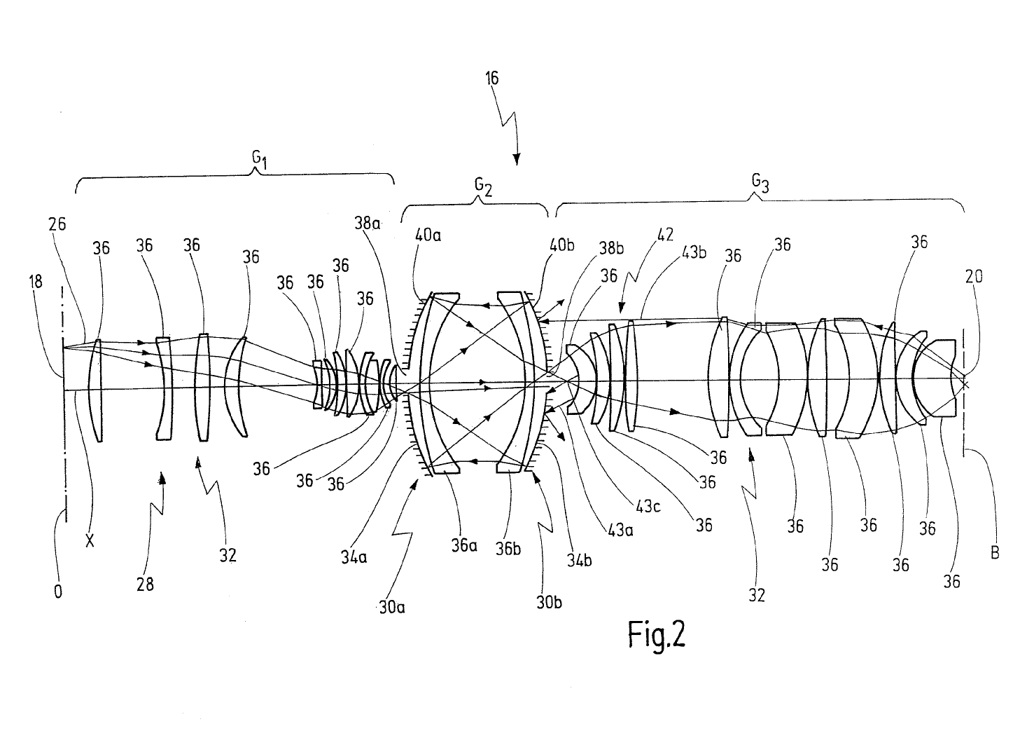

The exemplary embodiment of the projection objective 16 as illustrated in FIG. 2 has a plurality of optical elements 28. The projection objective 16 is of catadioptric design, that is to say that it has reflective elements 30, here two reflective elements 30a and 30b, and refractive elements 32. The reflective elements 30a, b are embodied as curved mirrors 34a,b and the refractive elements 32 are embodied as lenses 36 of widely varying form and aspherization. The optical elements 28 are arranged rotationally symmetrically with respect to a common straight optical axis X and therefore lie, in particular in the light propagation direction of the useful light downstream of the mirror 34b, on the common straight optical axis X.

The optical elements 28 of the projection objective 16 are subdivided into three subassemblies G₁, G₂ and G₃. The first and third subassemblies G₁ and G₃ as seen in the light propagation direction are dioptric and have only the lenses 36. The middle, catadioptric subassembly G₂ has the two mirrors 34a,b and also the two lenses 36a,b between the mirrors 34a,b.

The two mirrors 34a,b of the middle subassembly G₂ each have in their substrate 37a,b an approximately central and approximately identically sized opening 38a,b, the for example circular form of which is adapted to a course of the light beams 26 of the projection objective 16. In the exemplary embodiment shown, the openings 38a,b are arranged approximately rotationally symmetrically with respect to the optical axis X. Depending on the design of the projection objective 16, the mirrors 34a,b can also have in each case a plurality of openings 38a,b through which the light beams 26 can pass. The openings 38a,b can also be arranged non-rotationally symmetrically with respect to the optical axis X and at a distance from the optical axis X. The substrates 37a,b of the mirrors 34a,b are furthermore provided with light-reflecting surfaces 40a,b facing one another. The reflective surfaces 40a,b can be embodied as reflection coating.

The light beams 26 generated by the light source 12 ideally pass through the first subassembly G₁ as seen in the light propagation direction of the useful light of the projection objective 16 and are respectively deflected at the lenses 36 associated with said subassembly. Afterward, the light beams 26 enter into the second subassembly G₂ of the projection objective 16 through the opening 38a of the mirror 34a and are refracted at the lenses 36a,b of the second subassembly G₂. As illustrated in FIG. 2, those light beams 26 which pass through the opening 38a of the mirror 34a approximately parallel to the optical axis X are not deflected from their propagation direction and pass through the opening 38b of the mirror 34b. The light beams 26 which pass through the opening 38a of the mirror 34a obliquely with respect to the optical axis X are refracted at the lenses 36a,b in such a way that they impinge for example in an edge region of the light-reflecting surface 40b of the mirror 34b and are reflected there to the mirror 34a. These light beams 26 once again pass through the lenses 36a,b in the opposite order and impinge on the light-reflecting surface 40a of the mirror 34a in an edge region thereof. After reflection at said surface 40a of the mirror 34a, the light beams 26 pass through the two lenses 36a,b, pass through the opening 38b of the mirror 34b and pass through the lenses 36 of the third subassembly G₃ in order to impinge on the wafer 20 arranged in the image plane B of the projection objective 16.

The imaging quality of the projection objective 16 is determined by the imaging properties thereof, which is impaired in particular by stray light 42 or false light or so-called “ghost images”. Said stray light 42 can be caused by those light beams 43a,b which impinge on a rear side of the mirror 34b at arbitrary impingement angles, or else by those light beams 43, here represented by the light beam 43c by way of example, which, coming from the image plane B at least partly pass through the opening 38b of the mirror 34b and penetrate into the substrate 37b via substrate side walls of the mirror 34b obliquely with respect to the optical axis X. The light beams 43a-c that impinge on the mirror 34b rearward pass through a substrate extent of the mirror 34b and are reflected back at the light-reflecting surface 40b thereof. These light beams 43a-c mix with the light beams 26 running in the light propagation direction of the useful light and lead for example to distorted imagings of the pattern of the objective 18 onto the wafer 20.

FIG. 2 illustrates various causes of the stray light 42 by way of example. The light beam 43a, at surfaces of the lenses 36 of the third subassembly G₃, for example, rather than being transmitted, may be reflected back to the second subassembly G₂ and impinge on the mirror substrate 37b rearward. The stray light 42 may likewise arise as a result of the light beam 43b being reflected back at the wafer 20 into the projection objective 16, wherein the light beam 43b then passes, counter to the light propagation direction of the useful light, through the optical elements 28 of the subassembly G₃ adjacent to the image plane B in the opposite order and impinges on the mirror 34b rearward. Furthermore, the stray light can be caused as a result of the light beam 43c being reflected back at the surfaces of the lenses 36 of the third subassembly G₃, wherein the light beam 43c partly passes through the opening 38b of the mirror 34b and penetrates into the substrate 37b of the mirror 34b via the side walls of the substrate 37b that are adjacent to the opening 38b. Depending on the beam path, the light beams 43a-c can also run with omission of optical elements 28, which is illustrated by way of example by the beam course of the light beam 43b.

An effective suppression or at least a reduction of the stray light 42 is brought about by a choice of material for the mirror 34b of the catadioptric projection objective 16. The material of the mirror 34b can be light-absorbing, such that the stray light 42 impinging on the mirror 34b rearward is absorbed. In this case, the absorption property of the material is coordinated with the wavelength of the incident light beams 26, that is to say with the wavelength of the light source 12. The material of the mirror 34b can likewise be non-directionally light-scattering, whereby diffuse stray light conduction in all spatial directions leads to a distribution of the light beams 43a-c contributing to the stray light 42. In this case, the light beams 43a-c can be scattered away from the optical axis X and do not reach the image plane B of the projection objective 16.

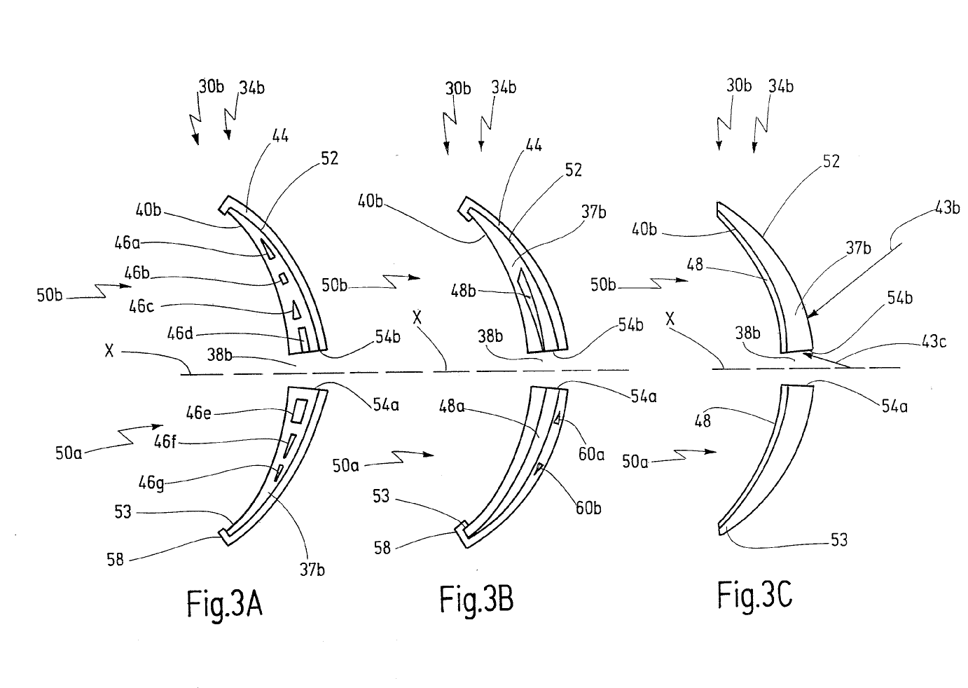

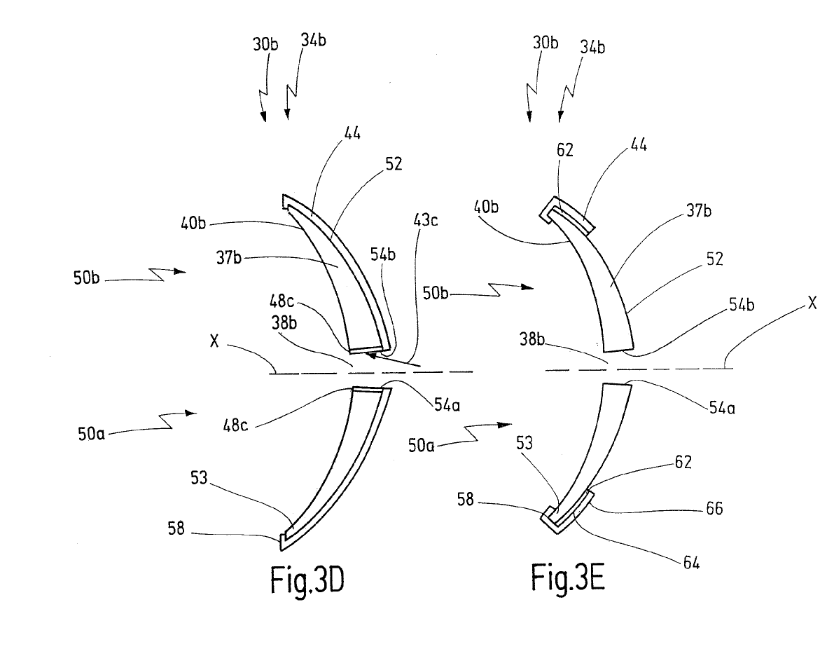

FIGS. 3A-E show, by way of example, various embodiments of the mirror 34b having a basic body, the substrate 37b, and a mount 44. The substrate 37b and/or the mount 44 of the mirror 34b can at least partly be made from the stray-light-suppressing material. In this case, the various embodiments of the substrate 34b and of the mount 44 for stray light suppression can be combined with one another in any desired manner or else be used by themselves.

As illustrated in FIG. 3A, the substrate 37b of the mirror 37b is at least partly made from the stray-light-suppressing or at least stray-light-reducing material. For this purpose, the mirror substrate 37b has seven substrate regions 46a-g situated approximately centrally in a substrate extent of the mirror 34b. The substrate regions 46a-g are embodied differently in terms of their dimensions, such that they are optimally adapted to the extent of the preferred impingement regions of the light beams 43a-c and to the intensity of the impinging stray light 42.

The substrate 37b of the mirror 34b can likewise have a stray-light-suppressing layer 48 (cf. FIG. 3B). The layers 48a,b applied in a first and second mirror half 50a,b, which are separated from one another by the opening 38b, are arranged under the reflective surface 40b of the substrate 37b as seen in the light propagation direction of the useful light. The layer 48a extends along an opposite side with respect to the reflective surface 40b, that is to say along a rear side 52 of the substrate, and its diameter decreases toward a substrate edge 53. The layer 48b provided in the mirror half 50b is situated approximately centrally in the mirror substrate 37b directly adjacent to the opening 38b and widens radially outward.

As illustrated in FIG. 3C, the layers 48a,b can be arranged directly under the reflective surface 40b of the substrate 37b as seen in the light propagation direction of the useful light. Furthermore, the layers 48a,b extend along the entire extent of the reflective surface 40b, with the result that optimum stray light suppression of the light beams 43a-c incident on the mirror substrate 37b rearward is achieved. The layers 48a,b arranged directly under the reflective surface 40b also suppress those light beams 43a-c which at least partly pass through the opening 38b and penetrate into the mirror substrate 37b via side walls 54a,b of the substrate 37b. This prevents, in particular, said light beams 43a-c from being able to pass to the reflective surface 40b of the mirror 34b. It goes without saying that the substrate 37b can have one or a plurality of side walls 54 depending on the geometry of the opening 38b.

It is likewise possible for the stray-light-suppressing layer 48c to be arranged at the side walls 54a,b of the substrate 37b, which layer nullifies the light beams 43a-c that pass through the opening 38b (cf. FIG. 3D). In the exemplary embodiment shown, the layer 48c is arranged along the entire extent of the side walls 34a,b of the substrate 37b of the mirror 34b. The stray-light-suppressing layer 48c can likewise be arranged only in partial regions along the side walls 54a,b or only along one side wall 54a,b.

It is likewise possible for the entire mirror substrate 37b to be made from the stray-light-suppressing material (cf. FIG. 3E). For this purpose, by way of example, homogeneously distributed particles composed of the stray-light-suppressing material can be introduced into the mirror substrate 37b.

The stray-light-suppressing material can be formed from Zerodur, which has a low expansion coefficient. This is advantageous particularly in the case of an intensive illumination of the projection objective 16 by the light source 12. Furthermore, this material is particularly homogeneous, such that it can easily be processed during mirror manufacture.

The mount 44 of the mirror 34b can be used additionally or exclusively for the stray light suppression. The mounts 44 of the mirror 34b that are shown in FIGS. 3A-B, 3D-3E are at least partly arranged at the rear side 52 of the substrate. The mount 44 extends for example along the entire rear side 52 of the substrate (cf. FIGS. 3A, 3B, 3D) or only in an outer ring-shaped partial region 56 of the substrate 37b (cf. FIG. 3E). The mount 44 furthermore has a radially outer projection 58, which points toward the reflective surface 40b of the substrate 37b and receives (cf. FIG. 3A) or encloses (cf. FIGS. 3B, 3D, 3E) the substrate edge 53. The mount 44 shown in FIG. 3E is advantageous, particularly in comparison with the mounts 44 illustrated in FIGS. 3A, 3B, 3D, if the stray light 42 impinges in the ring-shaped partial region 56 of the mirror 34b. This embodiment of the mount 44 is furthermore particularly space-saving, and the weight which acts on a mount fixture (not illustrated) in the projection objective 16 is simultaneously reduced.

The mount 44 can be formed completely from metal, for example, such that the stray light 42 is nullified by the mount 44, whereby the stray light 42 does not penetrate into the substrate 37b and, furthermore, no stray light 42 is conducted to the image plane B (cf. FIGS. 3A, 3D, 3E).

The mount 44 can also have partial regions 60, two partial regions 60a,b illustrated in FIG. 3B, which are made from the stray-light-suppressing metal. Said partial regions 60a,b can be enclosed in the mount 44 at those regions of a, for example otherwise light-transparent, mount material at which the stray light 42 can impinge. In FIG. 3b, the partial regions 60a,b are situated in the mirror half 50a, while the mirror half 50b is formed only from the transparent material.

It is likewise possible for the mount 44 to be covered with a stray-light-suppressing coating 62 composed of metal, for example, which is applied on a surface 64 of the mount 44 that faces the mirror substrate 37b (cf. FIG. 3E). The coating 62 can likewise be provided on a surface 66 of the mount 44 that faces away from the mirror substrate 37b. In the case of the coated mount 44, the remaining mount material can be embodied in light-transparent fashion.

If, by way of example, the substrate 37b of the mirror 34b is made completely from the stray-light-suppressing material or the layer 48a,b is formed along the entire extent of the reflective surface 40b of the mirror 37b, the mirror 37b can also be embodied without a mount 44 and be accommodated only at a holder (not illustrated) in the projection objective 16 (cf. FIG. 3C). The stray light suppression is then brought about solely by the substrate material.

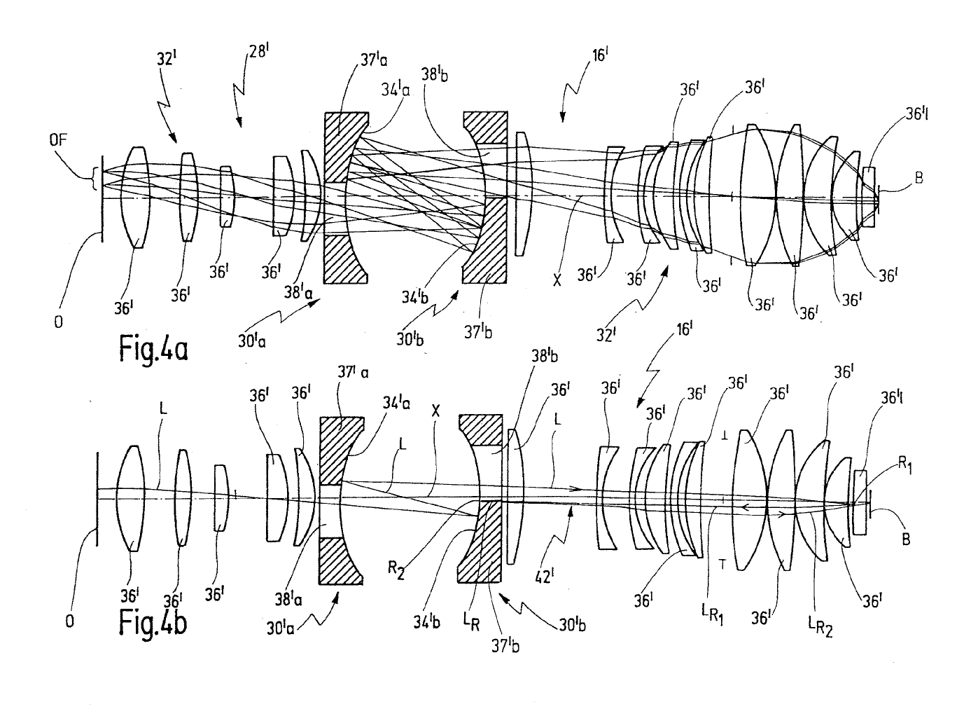

FIG. 4A illustrates a further exemplary embodiment of a projection objective 16′. The projection objective 16′ can be used instead of the projection objective 16 in the projection exposure apparatus 10 in FIG. 1.

In the case of the projection objective 16′, the components which are comparable or identical to the components of the projection objective 16 in FIG. 2 are provided with the same reference signs as in FIG. 2, supplemented by a′.

The projection objective 16′ is a catadioptric projection objective, the optical elements 28′ of which have two reflective elements 30′a and 30′b in the form of mirrors 34′a and 34′b and, moreover, 16 refractive elements 32′ in the form of lenses 36′.

The optical elements 28′ are arranged between an object plane O and an image plane B.

While the optical elements 28 of the projection objective 16 in FIG. 2 form an obscured imaging system, the optical elements 28′ of the projection objective 16′ in accordance with FIG. 4A form a non-obscured imaging system.

Although the reflective elements 30′a and 30′b of the projection objective 16′, like the corresponding reflective elements 30a and 30b of the projection objective 16, respectively have an opening 38′a and 38′b, the useful light impinges on the mirror 34a and the mirror 34′b in each case only on a mirror sector on one side of the opening 38′a and 38′b, respectively the beam path of said useful light being depicted in FIG. 4A. As emerges from a comparison with FIG. 2, in the case of the projection objective 16, the useful light impinges on the mirrors 34a and 34b in each case on both sides of the openings 38a and 38b. Those sectors of the reflective elements 30′a and 30′b illustrated in FIGS. 4A and b) on which the useful light does not impinge can also be omitted. The projection objective 16′ is correspondingly able to image an off-axis object field OF in the object plane O, that is to say an object field OF which does not contain the optical axis X, into the image plane B, to be precise onto an off-axis image field there.

In contrast to the projection objective 16 in FIG. 2, the space between the mirrors 34′a and 34′b is free of refractive elements, that is to say free of lenses.

As seen in the direction of light propagation, the mirror 34′b is the first mirror and the mirror 34′a is the second mirror, wherein the first mirror 34′b faces the image plane B and is geometrically closer to the image plane B than the mirror 34′a.

Arranged between the first mirror 34′b and the image plane B are a total of eleven lenses 36′, wherein the last lens is provided with the reference sign 36′l.

The arising of stray light and the harmful effect of such stray light on the imaging by the projection objective 16′ will now be described with reference to FIG. 4B. FIG. 4B shows the projection objective 16′, wherein only one light beam L proceeding from the object plane O is illustrated there. Proceeding from the image plane O, the light beam L passes firstly through the first five lenses 36′ and through the opening 38′a in the second reflective element 30′a and impinges on the first mirror 34′b. From there, the light beam L is reflected to the second mirror 34′a and from there passes through the opening 38′b in the first reflective element 30′b and passes through the next ten lenses 36′.

Consideration will now be given here, by way of example, to a reflection R₁ of the light beam L at the front surface of the last lens 36′l as seen in the light propagation direction. The reflection R₁ of the light beam L passes back as reflected light beam L_{R1} from the last lens 36′l through the ten lenses 36′ arranged upstream thereof and then penetrates into the substrate 37′b of the reflective element 30′b as far as the reflective surface of the mirror 34′b and impinges on said surface. The resulting reflection R₂ is reflected as light beam L_{R2} again in the direction of the image plane B and passes through the ten lenses 36′ and the last lens 36′l. The light beam L_{R2} passes into the image plane B, where it is superimposed on the useful light beams (cf. FIG. 4A) but does not contribute to proper imaging, but rather generates a ghost image.

In order to avoid the propagation of such stray light in the form of the reflected light beam L_{R2}, those measures for stray light suppression as have been described with reference to FIGS. 2 and 3A to 3E are provided at the reflective element 30′b, wherein individual or a plurality of these measures in accordance with FIGS. 3A to 3E can be provided at the reflective element 30′b. Further such measures can, of course, also be provided at the reflective element 30′a.

1. A projection objective configured to image an object in an object plane onto an image field in an image plane, the projection objective comprising:
a plurality of optical elements comprising at least one reflective element and at least one refractive element, the at least one refractive element lying, in a light propagation direction of useful light, downstream of the at least one reflective element on a common straight optical axis,
wherein the at least one reflective element has a substrate having at least one opening through which light beams can pass, the at least one reflective element is at least partly made from a material which suppresses stray light impinging on the reflective element in a rearward direction, and the projection objective is configured to be used in microlithography.

2. The projection objective of claim 1, wherein the substrate of the reflective element at least partly comprises the stray-light-suppressing material.

3. The projection objective of claim 1, wherein the substrate of the reflective element at least partly comprises a layer comprising the stray-light-suppressing material.

4. The projection objective of claim 3, wherein the layer is under a reflective surface of the substrate.

5. The projection objective of claim 4, wherein the layer is arranged directly under the reflective surface of the substrate.

6. The projection objective of claim 4, wherein the layer is arranged along an entire extent of the reflective surface of the substrate.

7. The projection objective of claim 3, wherein the layer is at least partly arranged along the opening of the substrate.

8. The projection objective of claim 1, wherein the reflective element has a mount arranged at least partly at a rear side of the substrate, and the mount at least partly comprises the stray-light-suppressing material.

9. The projection objective of claim 8, wherein the mount at least partly comprises a coating made from the stray-light-suppressing material.

10. The projection objective of claim 1, wherein the stray-light-suppressing material is light-absorbing.

11. The projection objective of claim 10, wherein the light-absorbing material is Zerodur.

12. The projection objective of claim 1, wherein the stray-light-suppressing material is non-directionally light-scattering.

13. The projection objective of claim 1, wherein the stray-light-suppressing material is metal.

14. The projection objective of claim 1, wherein the at least one reflective element is a mirror.

15. The projection objective of claim 1, wherein the optical elements form a non-obscured imaging system.

16. The projection objective of claim 15, wherein the object field is off-axis in the object plane and does not contain the common straight optical axis, and the image field in the image plane is off-axis.

17. The projection objective of claim 1, wherein only refractive elements are arranged downstream of the reflective element and upstream of the image plane as seen in the light propagation of the useful light, and wherein the stray light is produced by at least one reflection at at least one surface of the at least one of the refractive element.

18. The projection objective of claim 17, wherein the at least one surface of the last refractive element is upstream of the image plane.

19. The projection objective of claim 18, wherein the at least one surface of the at least one reflective element is a front surface of the last reflective element as seen in the light propagation direction.

20. An apparatus, comprising:
an illumination system; and
a projection objective according to anyone of claim 1,
wherein the apparatus is a microlithography projection exposure apparatus.
